(19) United States
(12) Patent Application Publication
(10) Pub. No.: US 2026/0288428 A1
(43) Pub. Date: Sep. 24, 2026

(54) GENERATING RECOMMENDATIONS FOR RELEVANT SOFTWARE FIXES

(71) Applicant: SAP SE, Walldorf (DE)

(72) Inventors: Ulrich Bielert, Nussloch (DE); James Odendal, Munich (DE); Andreas Vogel, Rauenberg (DE)

(21) Appl. No.: 19/087,828

(22) Filed: Mar. 24, 2025

(51) Int. Cl. G06F 8/35; G06N 20/00

(52) U.S. Cl. CPC G06F 8/35; G06N 20/00

(57) ABSTRACT

The present disclosure involves systems, software, and computer implemented methods for generating recommendations for relevant software fixes. One example method includes generating trend data for historical software issue notices for software products that indicate trends regarding implementations in deployments of the software products of corrections to the software products. A model is trained using the trend data, implementation counts for the historical software issue notices, and software issue notice metadata to predict whether a new software issue notice is relevant for a given software product deployment. A request is received for relevant software issue notices for a first software product deployment. The trained model determines a set of relevant software issue notices for the first software product deployment from among a set of recent software issue notices. A recommendation is generated based on the set of relevant software issue notices and is provided in response to the request.

### TECHNICAL FIELD

The present disclosure relates to computer-implemented methods, software, and systems for generating recommendations for relevant software fixes.

### BACKGROUND

A software provider may identify an issue with a software product and may provide a communication to customers of the software provider for which the software product has been deployed or installed regarding the issue. The communication may include instructions for how to resolve the issue. The communication can include a description of symptoms of the issue, a cause of the issue, an indication of a release version in which the issue occurs, and correction instructions for the issue. The correction instructions may include descriptions of one or more tasks that the customer can perform to resolve the issue. In some cases, the correction instructions refer to one or more support packages that can be installed, activated, or otherwise used to resolve the issue. In some cases, the communication can include workaround instructions for temporarily avoiding the issue until the correction instructions can be performed.

### SUMMARY

The present disclosure involves systems, software, and computer implemented methods for generating recommendations for relevant software fixes. An example method includes: generating trend data for historical software issue notices for software products provided by a software provider that indicate trends regarding implementations in deployments of the software products of corrections to the software products specified in the historical software issue notices; training a model, using the trend data, implementation counts for the historical software issue notices, and software issue notice metadata, to predict, as a trained model, whether a new software issue notice is relevant for a given software product deployment; receiving a request for relevant software issue notices for a first software product deployment; providing the request to the trained model; determining, by the trained model, a set of relevant software issue notices for the first software product deployment from among a set of recent software issue notices; generating a recommendation based on the set of relevant software issue notices; and providing the recommendation determined based on the set of relevant software issue notices in response to the request.

Implementations may include one or more of the following features. Generating the trend data for the historical software issue notices can include generating trend data based on implementation counts for the historical software issue notices for a predetermined number of previous days. Generating the trend data for the historical software issue notices can include generating trend data based on implementation counts for a predetermined number of days after release of respective historical software issue notices. Generating the trend data for the historical software issue notices can include generating trend data based on normalized implementation counts for respective historical software issue notices. A normalized implementation count for a historical software issue notice can be a ratio of an actual implementation count for the historical software issue notice to a possible implementation count for the historical software issue notice. Generating the trend data for the historical software issue notices can include generating trend data based on implementation counts since releases of respective historical software issue notices. Software issue notices can include or refer to code corrections for a software product and implementing the software issue notices comprises applying the code corrections to a deployed software product. The software issue notice metadata can include software issue notice titles, issue descriptions, correction descriptions, and references to affected software products or components. The method can include: comprising generating a second set of relevant software issue notices for the request using a second model; generating a merged recommendation using the recommendation generated based on the set of relevant software issue notices generated using the trained model and the second set of relevant software issue notices generated using the second model; and providing the merged recommendation is response to the request. The second model can be trained to generate the second set of relevant software issue notices based on one or more of software products installed on a system, previous implementations of other software issue notices on the system, or other characteristics of the system. Determining a first relevant software issue notice can include determining, by the trained model, that a predicted trend for the first relevant software issue notice is greater than a threshold popularity. The method can include: comparing actual implementation counts of software issue notices to predicted software issue notice implementation counts generated by the trained model; and updating the trained model based on a difference between the actual implementation counts and the predicted software issue notice implementation counts.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for generating recommendations for relevant software fixes.

FIG. 2 illustrates an example system.

FIGS. 3-5 illustrate example graphs.

FIG. 6 is a flowchart of an example method for generating recommendations for relevant software fixes.

### DETAILED DESCRIPTION

A software provider can release software issue notices that describe solutions for bugs or configuration issues in software provider systems or solutions. A software issue notice can include or refer to coding corrections and a description of the issue and the solution (e.g., from application and technical perspectives). The software provider can provide an implementation tool to enable customers to apply software issue notice corrections to their systems.

Customers generally want to receive timely information about necessary software issue notices for their systems to avoid potential serious problems. However, large software providers may, over time, generate a large number (e.g., millions) of software issue notices, which can present a challenge for customers for identifying correct and necessary (e.g., relevant) software issue notices. Even when filtering is provided for software issue notices that can identify potentially relevant software issue notices for a customer system based on a technical match, there may still be thousands of potentially relevant software issue notices for a customer. Furthermore, the software provider itself may be challenged to provide relevant support for identifying relevant notices since the software provider may have a large number of customer systems (e.g., hundreds or even thousands of customers), each of which can vary greatly with respect to technical configurations. Accordingly, various challenges can exist, as described above, for identifying relevant and necessary software issue notices for a customer.

An improved software issue notice recommendation tool can be used for identifying and providing recommendations for relevant software issue notices for a customer. The recommendation tool can generate trend data for software issue notices and train machine learning (ML)/artificial intelligence (AI) tool(s) based on the trend data and software issue notice implementation data to predict whether a new software issue notice is likely to be relevant for customer.

For example, a system administrator of a customer can use the recommendation tool (which may be included, for example, in a maintenance planner application) to check whether there are new software issue notices to be implemented on the customer's systems. The administrator can select relevant systems and for each selected system the recommendation tool can determine and present a set of recommended software issue notices that have been determined by the ML/AI tools to likely be relevant for the customer.

The improved recommendation tool can provide various advantages over other approaches such as those that use plausibility checks or text analysis. The recommendation tool can generate recommendations based on empirical data regarding timing of software issue notice adaptation in software provider customer systems. The recommendation tool can make recommendations that offer important insight into relevant importance of software issue notices for software provider customers in general. The recommendation tool can leverage AI/ML tools that have been trained using the empirical data. The recommendation tool can generate intelligent recommendations for a software issue notice immediately after the software issue notice is released, offering timeliness advantages as compared to other approaches that rely on data gathering for the particular software notice for a number of days after notice creation. Moreover, the recommendation tool can be improved over time by comparing predictions of recommendations to actual future software issue notice implementation counts and updating models based on the comparison.

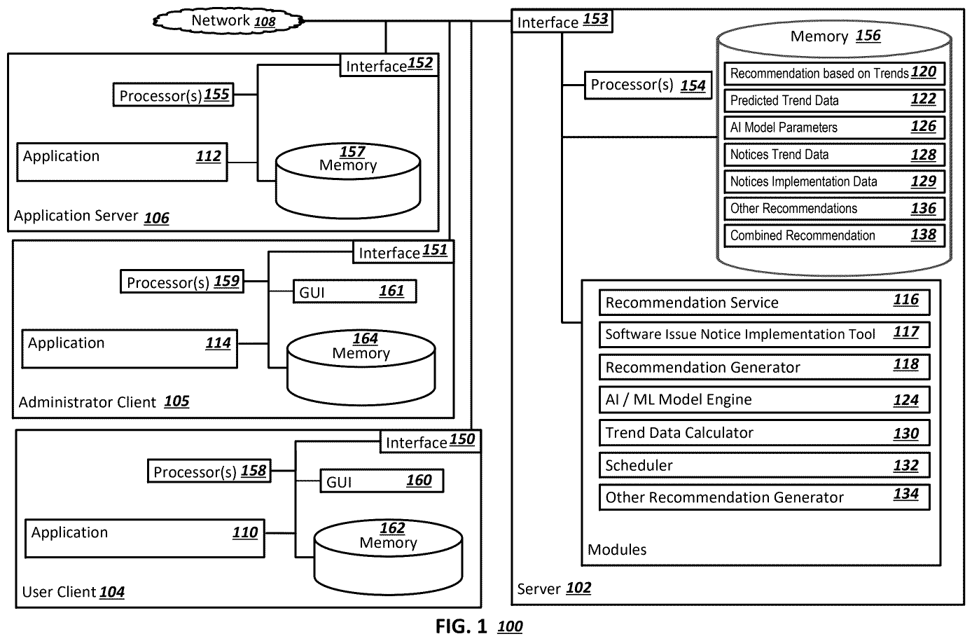

FIG. 1 is a block diagram illustrating an example system 100 for generating recommendations for relevant software fixes. Specifically, the illustrated system 100 includes or is communicably coupled with a server 102, an end-user client device 104, an administrator client device 105, an application server 106, and a network 108. Although shown separately, in some implementations, functionality of two or more systems or servers may be provided by a single system or server. In some implementations, the functionality of one illustrated system, server, or component may be provided by multiple systems, servers, or components, respectively.

A user can use the end-user client device 104 to access various types of applications. An application 110 can be, for example, a client-side version of an application 112 provided by the application server 106. An administrator can use an application 114 on the administrator client device 105 to discover and to trigger implementation of software issue notices that may be relevant to the application 112 (or in some cases the application 110) or other applications or systems in a customer environment. The application 114 can send a request for relevant software issue notices to the server 102, for example.

The server 102 can include a recommendation service 116 that can receive the request. The recommendation service 116 can provide a recommendation for relevant software issue notices to the application 114. The administrator can use the application 114 to trigger implementation of software corrections (e.g., code corrections) associated with selected recommended software issue notices by a software issue notice implementation tool 117.

The recommendation service 116 can use a recommendation generator 118 that can generate a recommendation 120 based on predicted software issue notice implementation trend data 122. The recommendation generator 118 can use an AI/ML model engine 124 to generate the predicted software issue notice implementation trend data 122, where the AI/ML model engine 124 is configured using AI/ML model parameters 126.

The AI/ML model parameters 126 can be determined during model training. The AI/ML model engine 124 can be trained, for example, based on software issue notices trend data 128, software issue notices implementation data 129 (e.g., implementation counts), and other information about software issue notices. The software issue notices trend data 128 can be generated by a trend data calculator 130. For example, a scheduler 132 can periodically (e.g., daily) invoke the trend data calculator 130 to generate updated trend data.

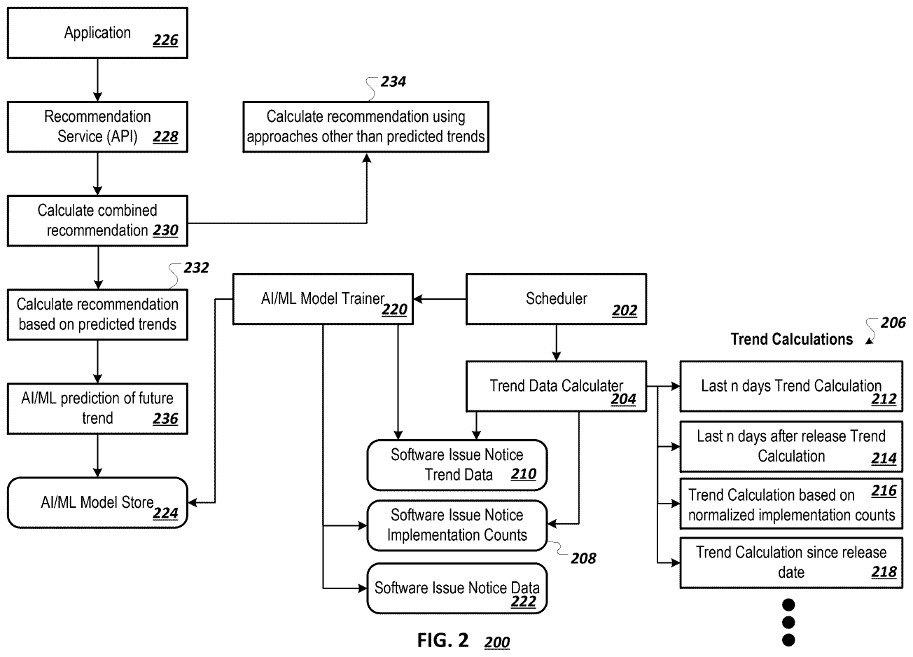

In some cases, the server 102 can include or use another recommendation generator 134, which can generate other recommendation(s) 136 using approaches other than predicted trends (e.g., recommending based on current installed software, currently implemented software issue notices, etc., as described below). In some cases, the recommendation service 116 generates and provides a combined recommendation 138 which combines the recommendation 120 based on predicted trends and the other recommendation(s) 136. FIG. 2, discussed below, illustrates further details regarding software issue notice recommendation, trend data calculation, and predicted trends.

As used in the present disclosure, the term “computer” is intended to encompass any suitable processing device. For example, although FIG. 1 illustrates a single server 102, a single end-user client device 104, a single administrator client device 105, and a single application server 106, the system 100 can be implemented using multiples of such devices. Indeed, each illustrated device may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the illustrated devices may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 150, 151, 152, and 153 are used by the end-user client device 104, the administrator client device 105, the application server 106, and the server 102, respectively, for communicating with other systems in a distributed environment including within the system 100—connected to the network 108. Generally, the interfaces 150, 151, 152, and 153 each comprise logic encoded in software and/or hardware in a suitable combination and operable to communicate with the network 108. More specifically, the interfaces 150, 151, 152, and 153 may each comprise software supporting one or more communication protocols associated with communications such that the network 108 or interface's hardware is operable to communicate physical signals within and outside of the illustrated system 100.

The server 102 and the application server 106 includes one or more processors 154 or 155, respectively. Each processor in the processors 154 or 155 may be a central processing unit (CPU), a blade, an application specific integrated circuit (ASIC), a field-programmable gate array (FPGA), or another suitable component. Generally, each processor in the processors 154 or 155 executes instructions and manipulates data to perform the operations of the server 102 or the application server 106, respectively. Specifically, each processor in the processors 154 or 155 executes the functionality required to receive and respond to requests from client devices such as the end-user client device 104 or the administrator client device 105.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, Python, ABAP, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102 and the application server 106 includes memory 156 or 157, respectively. In some implementations, the server 102 and/or the application server 106 includes multiple memories. The memory 156 and the memory 157 may each include any type of memory or database module and may take the form of volatile and/or non-volatile memory including, without limitation, magnetic media, optical media, random access memory (RAM), read-only memory (ROM), removable media, or any other suitable local or remote memory component. The memory 156 and the memory 157 may each store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server 102 or the application server 106, respectively.

The end-user client device 104 and the administrator client device 105 may each generally be any computing device operable to connect to or communicate with the server 102 or the application server 106 via the network 108 using a wireline or wireless connection. In general, the end-user client device 104 and the administrator client device 105 each comprise an electronic computer device operable to receive, transmit, process, and store any appropriate data associated with the system 100 of FIG. 1. The end-user client device 104 and the administrator client device 105 can each include one or more client applications, including the application 110 or the application 114, respectively. A client application is any type of application that allows the a respective client device to request and view content on the client device. In some implementations, a client application can use parameters, metadata, and other information received at launch to access a particular set of data from the server 102 or the application server 106. In some instances, a client application may be an agent or client-side version of the one or more enterprise applications running on an enterprise server (not shown).

The end-user client device 104 and the administrator client device 105 each further include one or more processors 158 or 159, respectively. Each processor in the processors 158 or 159 may be a central processing unit (CPU), an application specific integrated circuit (ASIC), a field-programmable gate array (FPGA), or another suitable component. Generally, each processor in the processors 158 or 159 executes instructions and manipulates data to perform the operations of the end-user client device 104 or the administrator client device 105, respectively. Specifically, each processor in the processors 158 or 159 executes the functionality required to send requests to the server 102 and/or the application server 106 and to receive and process responses from the server 102 and/or the application server 106.

The end-user client device 104 and the administrator client device 105 are each generally intended to encompass any client computing device such as a laptop/notebook computer, wireless data port, smart phone, personal data assistant (PDA), tablet computing device, one or more processors within these devices, or any other suitable processing device. For example, the end-user client device 104 and/or the administrator client device 105 may comprise a computer that includes an input device, such as a keypad, touch screen, or other device that can accept user information, and an output device that conveys information associated with the operation of the server 102 or the application server 106, or the client device itself, including digital data, visual information, or a GUI (Graphical User Interface) 160 or 161, respectively.

The GUIs 160 and 161 each interface with at least a portion of the system 100 for any suitable purpose, including generating a visual representation of the application 110 or the application 114, respectively. In particular, the GUIs 160 and 161 may each be used to view and navigate various Web pages, or other user interfaces. Generally, the GUIs 160 and 161 each provide the user with an efficient and user-friendly presentation of business data provided by or communicated within the system. The GUIs 160 and 161 may each comprise a plurality of customizable frames or views having interactive fields, pull-down lists, and buttons operated by the user. The GUIs 160 and 161 each contemplate any suitable graphical user interface, such as a combination of a generic web browser, intelligent engine, and command line interface (CLI) that processes information and efficiently presents the results to the user visually.

Memory 162 or 164 included in the end-user client device 104 or the administrator client device 105, respectively, may include any memory or database module and may take the form of volatile or non-volatile memory including, without limitation, magnetic media, optical media, random access memory (RAM), read-only memory (ROM), removable media, or any other suitable local or remote memory component. The memory 162 and the memory 164 may each store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the respective client device.

There may be one or more additional end-user client devices 104 and/or administrator client devices 105 external to the illustrated portion of system 100 that are capable of interacting with the system 100 via the network 108. Further, the term “client”, “client device” and “user” may be used interchangeably as appropriate without departing from the scope of this disclosure. Moreover, while the end-user client device 104 and the administrator client device 105 may be described in terms of being used by a single user, this disclosure contemplates that many users may use one computer, or that one user may use multiple computers.

FIG. 2 illustrates an example system 200. The system 200 includes a scheduler 202 that is configured to invoke a trend data calculator 204 on a periodic basis (e.g., daily). The trend data calculator 204 can perform various trend calculations 206 using various algorithms and sub-engines. The trend data calculator 204 can perform the trend calculations 206 for each software issue notice using data included in a software issue notice implementation count repository 208.

The software issue notice implementation count repository 208 can be, for example, a database that is updated periodically (e.g., daily) to include information from customer systems (e.g., technical landscape information) regarding the customer systems and software issue notices that have been implemented on those customer systems. The trend data calculator 204 can store calculated trend data in a software issue notice trend data repository 210. The software issue notice trend data repository 210 can include trend data for each software issue notice for which trend data has been calculated.

As mentioned and as described below, the trend data calculator 204 can use different algorithms/sub-engines for trend data calculation. Using multiple algorithms/types of trend data calculation can provide richer insight data for software issue notice relevance prediction than if just one type of trend data calculation was performed. The trend calculations 206 include different examples of trend calculations, but other types of trend calculations can be performed. Illustrated examples include calculations for a trend for recent days (e.g., last n days), a trend for the first days after the release of a software issue notice, a percentage of systems where a notice has been implemented (e.g., normalized implementation numbers), and overall trend metrics since the release of the notice.

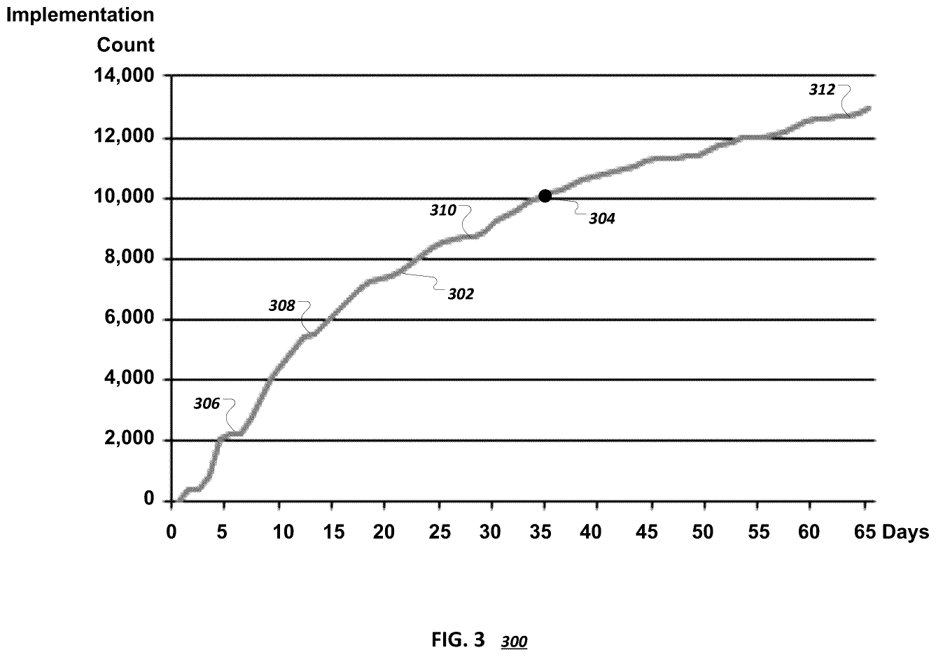

In further detail on trend data calculation, a last-n-days-trend-calculation sub-engine 212 can calculate (or be used to calculate) trend data for a software issue notice based on implementation counts for the notice for a previous n days. As shown below for FIG. 3, the last-n-days-trend-calculation sub-engine 212 can create a graph of implementation counts for the previous n days. In some implementations, the last-n-days-trend-calculation sub-engine 212 can use linear regression to calculate a slope of a graph curve for a given interval. Slope data can be stored as trend data/metadata.

FIG. 3 illustrates an example graph 300. The graph 300 has a Y-axis corresponding to implementation counts for a particular software issue notice and an X-axis corresponding to days since the software issue notice was created. A curve 302 shows implementation counts for the software issue notice for a sixty five day period. As an example, a point 304 indicates that on day thirty five of the sixty five day period, ten thousand customers had implemented change(s) to a software product in accordance with the software issue notice. The graph 300 can include flatter portions 306, 308, 310, etc., than can correspond, for example, to weekend dates during which fewer software issue notice implementations occurred. A later portion 312 of the graph 300 can represent an overall flattening of the curve 302 that represents an implementation count saturation (e.g., of about 13,000 implementations).

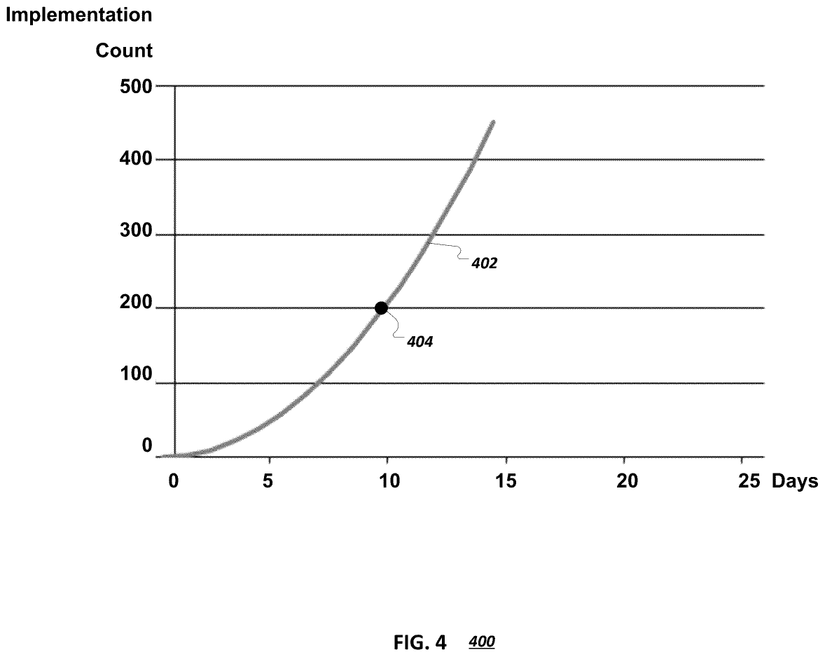

Referring again to FIG. 2, a last-n-days-after-release-trend-calculation sub-engine 214 can calculate (or be used to calculate) trend data for a software issue notice based on implementation counts for the notice for a previous n days since a release of the notice. As shown below for FIG. 4, the last-n-days-trend-calculation sub-engine 212 can create a graph of implementation counts for the previous n days since a release of the notice. In some implementations, the last-n-days-after-release-trend-calculation sub-engine 212 can analyze the graph to determine characteristics of a trend, such as logarithmic, linear, exponential.

FIG. 4 illustrates an example graph 400. The graph 400 has a Y-axis corresponding to implementation counts for a particular software issue notice and an X-axis corresponding to days since the software issue notice was created (e.g., released). A line 402 shows implementation counts for a first number of days (e.g., twenty five days) since the software issue notice was released. As an example, a point 404 indicates that on day ten, two hundred customers had implemented change(s) to a software product in accordance with the software issue notice. The line 402 can be analyzed to determine a trend and whether the trend exhibits certain characteristics (e.g., logarithmic, linear, exponential).

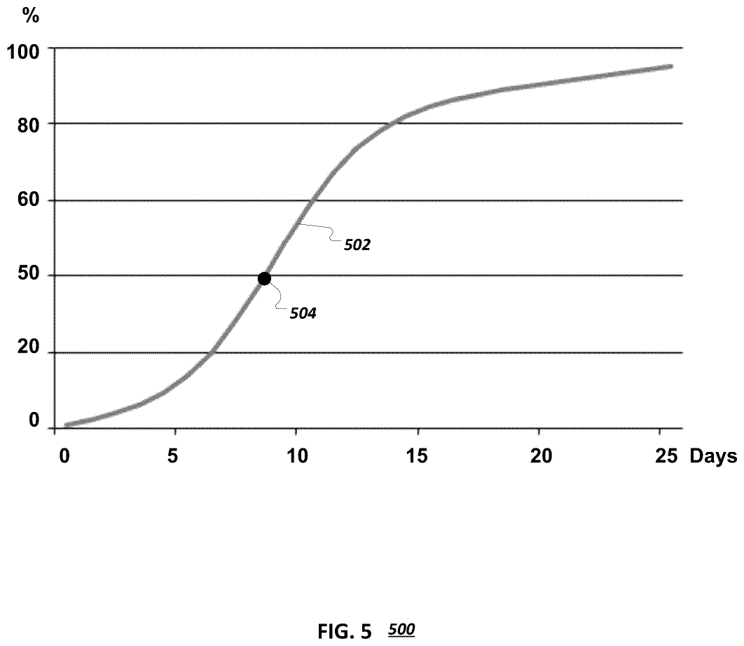

Referring again to FIG. 2, a trend-calculation-based-on-normalized-counts sub-engine 216 can calculate trend data for a software issue notice based on normalized implementation counts. The trend-calculation-based-on-normalized-counts sub-engine 216 can calculate a possible number of implementations for a software issue notice and from that calculate normalized trend characteristics such as a percentage of implementations. The normalized trend characteristics can be plotted on a graph, such as shown below for FIG. 5, and the trend-calculation-based-on-normalized-counts sub-engine 216 can determine whether the graph follows a logistic function, for example.

FIG. 5 illustrates an example graph 500. The graph 500 has a Y-axis corresponding to a percentage of current implementations (out of a number of possible implementations) for a particular software issue notice and an X-axis corresponding to days since the software issue notice was created. A curve 502 shows an implementation percentage for a first number of days (e.g., twenty five days) since the software issue notice was created. As an example, a point 504 indicates that on day nine, fifty percent of customers who potentially could implement change(s) to a software product have implemented those changes. The curve 502 can be analyzed to determine a trend and whether the trend exhibits certain characteristics (e.g., logarithmic, linear, exponential).

Referring again to FIG. 2, other trend calculations can be generated. For instance, a trend-calculation-since-release-date sub-engine 218 can analyze long-term trend data from a release date of a software issue notice until a current date. A logistic function can be used to characterize a curve of implementation statistics (e.g., the curve 502) which can lead to calculation of regression values and a projected saturation level. For instance, for the curve 502, the presented normalized implementation numbers indicate that a saturation level is approaching implementation for 100% of applicable systems.

An AI/ML model trainer 220 can read data from the software issue notice trend data repository 210, data from the software issue notice implementation count repository 208, and data from a software issue notice repository 222. The software issue notice repository 222 can include technical information regarding software issue notices, including notice identifiers, notice release date, notice title, notice description, code or other corrections to correct the issue, software component version information for affected components, and other information. The AI/ML model trainer 220 can train one or more models to predict future software issue notice implementation trend data for new software issue notices (e.g., predicting a trend before a trend occurs). The AI/ML model trainer 220 can store determined model parameters in an AI/ML model store 224.

In an inference phase, an application 226 can be used, for example, by an administrator, to determine which software issue notices may be relevant for a customer system. The application 226 can invoke a recommendation service 228 to request a recommendation for relevant software issue notices. The recommendation service 228 (which may be a REST (REpresentational State Transfer) API (Application Programming Interface)) can use a recommendation combiner 230 which can request, receive, and combine a first recommendation from a recommendation calculator 232 that calculates recommendations based on predicted trends and a second recommendation from a recommendation calculator 234 that calculates recommendations using other approaches.

The recommendation calculator 234 may use one or more models to generate a recommendation for relevant software issue notices based, for example, on information indicating which software issue notices have already been implemented on the customer system, which software products are installed on the customer system, what software is installed on other systems for which the software issue notice has been implemented, etc. The recommendation calculator 234 may use various approaches, such as collaborative filtering, cosine similarity matching, etc.

The recommendation calculator 232 can generate a recommendation based on an AI/ML future trend predictor 236. The AI/ML future trend predictor 236 can apply model information from the AI/ML model store 224 to one or more models and use the models to generate predictions for future implementation trends for recently-created software issue notices. The recommendation calculator 232 can identify particular software issue notices as recommended software issue notices for the customer for those software issue notices for which a predicted trend is at least a threshold predicted popularity, or at least a threshold predicted popularity within a predetermined number of days, etc.

The recommendation combiner 230 can create a merged list of recommended software issue notices (e.g., removing duplicates that have been recommended by both the recommendation calculator 232 and the recommendation calculator 234, using one or more thresholding approaches to keep only a certain number of most-highly recommended software issue notices, etc.). The merged list can be ranked by relevance (e.g., by recommendation score). The recommendation combiner 230 can provide the merged list of recommended software issue notices to the recommendation service 228 which in turn can provide the merged list of recommended software issue notices to the application 226. The administrator can proceed to use a software issue notice implementation tool to implement selected recommended software issue notices.

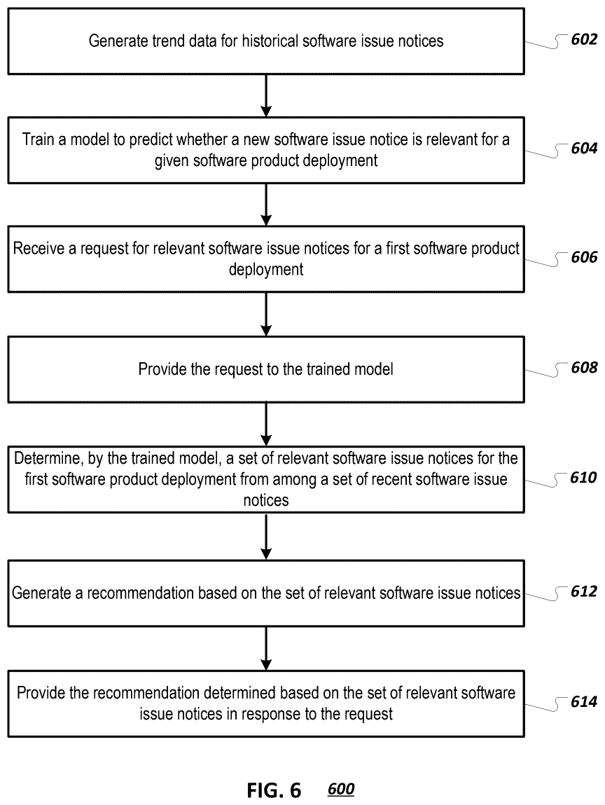

FIG. 6 is a flowchart of an example method for generating recommendations for relevant software fixes. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of a client, the server, or the other computing device. In some implementations, the method 600 and related methods are executed by one or more components of the system 100 described above with respect to FIG. 1. For example, the method 600 and related methods can be executed by the server 102 of FIG. 1.

At 602, trend data is generated for historical software issue notices for software products provided by a software provider that indicate trends regarding implementations in deployments of the software products of corrections to the software products specified in the historical software issue notices. Generating the trend data can include generating trend data based on implementation counts for the historical software issue notices for a predetermined number of previous days, generating trend data based on implementation counts for a predetermined number of days after release of respective historical software issue notices, generating trend data based on implementation counts since releases of respective historical software issue notices, or generating trend data based on normalized implementation counts for respective historical software issue notices. A normalized implementation count for a historical software issue notice can be determined as a ratio of an actual implementation count for the historical software issue notice to a possible implementation count for the historical software issue notice. Software issue notices can include or refer to code corrections for a software product and implementing the software issue notices can include applying the code corrections to a deployed software product.

At 604, a model is trained, using the trend data, implementation counts for the historical software issue notices, and software issue notice metadata, to predict, as a trained model, whether a new software issue notice is relevant for a given software product deployment. The model can be an AI model, an ML model, etc. The software issue notice metadata can include software issue notice titles, issue descriptions, correction descriptions, and references to affected software products or components

At 606, a request is received for relevant software issue notices for a first software product deployment.

At 608, the request is provided to the trained model.

At 610, the trained model determines a set of relevant software issue notices for the first software product deployment from among a set of recent software issue notices. The trained model can determine predicted trends for the recent software issue notices. The trained model can determine that a predicted trend for a first relevant software issue notice is greater than a threshold popularity and can identify the first relevant software issue notice as a relevant software issue notice for the request.

At 612, a recommendation is generated based on the set of relevant software issue notices.

At 614, the recommendation determined based on the set of relevant software issue notices is provided in response to the request. In some implementations, a second set of relevant software issue notices for the request can be generated using a second model and a merged recommendation can be generated using the recommendation generated based on the set of relevant software issue notices generated using the trained model and the second set of relevant software issue notices generated using the second model. The second model can be trained to generate the second set of relevant software issue notices based on one or more of software products installed on a system, previous implementations of other software issue notices on the system, or other characteristics of the system.

Actual implementation counts of software issue notices can be compared to predicted software issue notice implementation counts generated by the trained model. The trained model can be updated based on based on a difference between the actual implementation counts and the predicted software issue notice implementation counts.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
generating trend data for historical software issue notices for software products provided by a software provider that indicate trends regarding implementations in deployments of the software products of corrections to the software products specified in the historical software issue notices;
training a model, using the trend data, implementation counts for the historical software issue notices, and software issue notice metadata, to predict, as a trained model, whether a new software issue notice is relevant for a given software product deployment;
receiving a request for relevant software issue notices for a first software product deployment;
providing the request to the trained model;
determining, by the trained model, a set of relevant software issue notices for the first software product deployment from among a set of recent software issue notices;
generating a recommendation based on the set of relevant software issue notices; and
providing the recommendation determined based on the set of relevant software issue notices in response to the request.

2. The computer-implemented method of claim 1, wherein generating the trend data for the historical software issue notices comprises generating trend data based on implementation counts for the historical software issue notices for a predetermined number of previous days.

3. The computer-implemented method of claim 1, wherein generating the trend data for the historical software issue notices comprises generating trend data based on implementation counts for a predetermined number of days after release of respective historical software issue notices.

4. The computer-implemented method of claim 1, wherein generating the trend data for the historical software issue notices comprises generating trend data based on normalized implementation counts for respective historical software issue notices.

5. The computer-implemented method of claim 4, wherein a normalized implementation count for a historical software issue notice comprises a ratio of an actual implementation count for the historical software issue notice to a possible implementation count for the historical software issue notice.

6. The computer-implemented method of claim 1, wherein generating the trend data for the historical software issue notices comprises generating trend data based on implementation counts since releases of respective historical software issue notices.

7. The computer-implemented method of claim 1, wherein software issue notices include or refer to code corrections for a software product and implementing the software issue notices comprises applying the code corrections to a deployed software product.

8. The computer-implemented method of claim 1, wherein the software issue notice metadata includes software issue notice titles, issue descriptions, correction descriptions, and references to affected software products or components.

9. The computer-implemented method of claim 1, further:
comprising generating a second set of relevant software issue notices for the request using a second model;
generating a merged recommendation using the recommendation generated based on the set of relevant software issue notices generated using the trained model and the second set of relevant software issue notices generated using the second model; and
providing the merged recommendation is response to the request.

10. The computer-implemented method of claim 9, wherein the second model is trained to generate the second set of relevant software issue notices based on one or more of software products installed on a system, previous implementations of other software issue notices on the system, or other characteristics of the system.

11. The computer-implemented method of claim 1, wherein determining a first relevant software issue notice comprises determining, by the trained model, that a predicted trend for the first relevant software issue notice is greater than a threshold popularity.

12. The computer-implemented method of claim 1, further comprising:
comparing actual implementation counts of software issue notices to predicted software issue notice implementation counts generated by the trained model; and
updating the trained model based on a difference between the actual implementation counts and the predicted software issue notice implementation counts.

13. A system comprising:
one or more computers; and
a computer-readable medium coupled to the one or more computers having instructions stored thereon which, when executed by the one or more computers, cause the one or more computers to perform operations comprising
generating trend data for historical software issue notices for software products provided by a software provider that indicate trends regarding implementations in deployments of the software products of corrections to the software products specified in the historical software issue notices;
training a model, using the trend data, implementation counts for the historical software issue notices, and software issue notice metadata, to predict, as a trained model, whether a new software issue notice is relevant for a given software product deployment;
receiving a request for relevant software issue notices for a first software product deployment;
providing the request to the trained model;
determining, by the trained model, a set of relevant software issue notices for the first software product deployment from among a set of recent software issue notices;
generating a recommendation based on the set of relevant software issue notices; and
providing the recommendation determined based on the set of relevant software issue notices in response to the request.

14. The system of claim 13, wherein generating the trend data for the historical software issue notices comprises generating trend data based on implementation counts for the historical software issue notices for a predetermined number of previous days.

15. The system of claim 13, wherein generating the trend data for the historical software issue notices comprises generating trend data based on implementation counts for a predetermined number of days after release of respective historical software issue notices.

16. The system of claim 13, wherein generating the trend data for the historical software issue notices comprises generating trend data based on normalized implementation counts for respective historical software issue notices.

17. A computer program product encoded on a non-transitory storage medium, the product comprising non-transitory, computer readable instructions for causing one or more processors to perform operations comprising:
generating trend data for historical software issue notices for software products provided by a software provider that indicate trends regarding implementations in deployments of the software products of corrections to the software products specified in the historical software issue notices;
training a model, using the trend data, implementation counts for the historical software issue notices, and software issue notice metadata, to predict, as a trained model, whether a new software issue notice is relevant for a given software product deployment;
receiving a request for relevant software issue notices for a first software product deployment;
providing the request to the trained model;
determining, by the trained model, a set of relevant software issue notices for the first software product deployment from among a set of recent software issue notices;
generating a recommendation based on the set of relevant software issue notices; and
providing the recommendation determined based on the set of relevant software issue notices in response to the request.

18. The computer program product of claim 17, wherein generating the trend data for the historical software issue notices comprises generating trend data based on implementation counts for the historical software issue notices for a predetermined number of previous days.

19. The computer program product of claim 17, wherein generating the trend data for the historical software issue notices comprises generating trend data based on implementation counts for a predetermined number of days after release of respective historical software issue notices.

20. The computer program product of claim 17, wherein generating the trend data for the historical software issue notices comprises generating trend data based on normalized implementation counts for respective historical software issue notices.
